(19) United States
(12) Patent Application Publication
(10) Pub. No.: US 2026/0187259 A1
(43) Pub. Date: Jul. 2, 2026

(54) EMULATING LOCAL DATABASE CONNECTIONS AS A REMOTE SERVICE FOR CUSTOM TOOLS DEVELOPED FOR COLLABORATION SYSTEMS

(71) Applicant: Atlassian Pty Ltd., Sydney (AU)

(72) Inventors: Varun Arbatti, Asquith (AU); James Dumay, Newtown (AU)

(21) Appl. No.: 19/002,673

(22) Filed: Dec. 26, 2024

(51) Int. Cl. G06F 21/60

(52) U.S. Cl. CPC G06F 21/606

(57) ABSTRACT

Systems and methods for emulating local database connections for custom tools (e.g., macros, integrations, plugins, and the like) designed to integrate with collaboration platforms. An emulated connection can be supported by a set of protocol bridges. A first protocol bridge is instantiated local to a custom tool and a second protocol bridge is instantiated in a collaboration system backend. The two protocol bridges level shift transport layer communications supporting a database connection between the custom tool and a remote relational database of the collaboration system backend to application layer communications that traverse secure networks and that can be authenticated and monitored by collaboration system authentication systems.

### TECHNICAL FIELD

Embodiments described herein relate to data security and data management systems for multi-user collaboration systems and, in particular, to systems and methods for providing a local database connection as a secure remote service.

### BACKGROUND

Organizations license access, for their employees or customers, to one or more collaboration systems to generate, view, and/or modify digital content. In some cases, an organization may leverage one or more first-party or third-party tools, plugins, integrations, scripts, or macros to manage collaboration system data in a custom way. Developers and maintainers of such custom tools typically prefer to use tool-specific databases to retain information related to the operation of those custom tools.

However, conventional data storage functionality available to developers of custom tools for collaboration systems is limited to application layer protocols and custom application programming interfaces (APIs), requiring bespoke software design patterns and data management techniques, which in turn define an unknown information security vulnerability surface that is difficult to manage and secure. In this manner, development of secure and functional custom tools for collaboration systems can be both time consuming and expensive, an effort that may not be viewed as practical in comparison to the utility provided by those custom tools. As a result, many developers implement problematic workarounds to store data outside of collaboration system firewalls, introducing a significant risk of organization data loss or theft.

### SUMMARY

Embodiments described herein take the form of a computer-implemented method of providing access via a collaboration system to a relational database as a service over a network, the method including the operations of: receiving, at a backend of the collaboration system, an application layer data via the network to access a relational database, the application layer data including an authentication token; determining that the authentication token is associated with permission to access at least one resource of the collaboration system, and in response, establishing a connection between the backend of the collaboration system and an originator of the application layer data; receiving, via the connection, first packaged application layer data; unpackaging, as transport layer data, the first packaged application layer data; the transport layer data with a query of the relational database; providing, by the collaboration system, the query to the relational database and, in response, receiving a result; packaging the result as second packaged application layer data; and transmitting, via the connection, the second packaged application layer data to the originator.

Some embodiments described herein take the form of a computer-implemented method of accessing over a network a remote relational database hosted by a collaboration system, the method including steps such as: requesting, via invocation of a function, to query the remote relational database; receiving first transport layer data associated with the query of the remote relational database; packaging the transport layer data as first application layer data, assembling a first application layer data, the application layer data with an authentication token and the first application layer data; transmitting the first application layer data to the collaboration system over the network; receiving, in response to the first application layer data, a second application layer data with second application layer data; unpackaging the second application layer data to extract second transport layer data received from the remote relational database in response to the connection request; and providing to the function, the second transport layer data as a response from the remote relational database.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIG. 1 depicts a simplified system diagram of a remote database connection management system.

FIG. 2 depicts a simplified system diagram of a collaboration system including a remote database connection management system as described herein.

FIG. 3 depicts a simplified system diagram of a collaboration system including a remote database connection management system with application layer authentication as described herein.

FIG. 4 depicts an example graphical user interface that may be rendered on a client device of a collaboration system integrated with one or more automatically or manually-invoked custom tools.

FIG. 5 depicts a flowchart depicting operations of another method of operating a remote database connection management system as described herein.

FIG. 6 depicts a flowchart depicting operations of another method of operating a remote database connection management system as described herein.

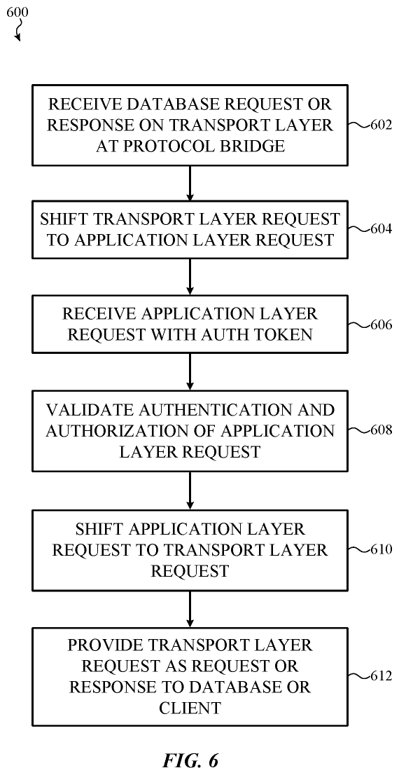

The use of the same or similar reference numerals in different figures indicates similar, related, or identical items.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein relate to collaboration systems that expose application programming interfaces (APIs) for use by developers to introduce custom functionality or custom behaviors to such collaboration systems.

In particular, embodiments described herein relate to relational database management services (RDBMs) that can be used, as a remote-hosted secure and authenticated service, by developers and/or maintainers of custom software that leverage collaboration systems APIs. In this manner, developers of custom software, integrations, plugins, and/or macros (herein, broadly, “custom tools”) for collaboration systems can (1) leverage robust, mature, and well-supported database management libraries/frameworks, (2) use well-understood and common software design patterns for such custom tools and (3) can implement industry standard database management best practices all without requiring local storage, backup, or management. Further, as a result of the systems and methods described herein, existing application layer authentication and authorization systems can be used to gate access to databases used by custom tools.

These embodiments greatly increase the information security of collaboration systems, without limiting the expandability of those systems (e.g., by limiting API access). More specifically, by providing developers with a familiar data management and storage environment, developers are more likely to use industry-standard software design patterns and well-tested data management frameworks and libraries. Further, by retaining custom tool data within an authenticated environment, access to that data, whether from a custom tool or otherwise, can be controlled.

A “collaboration system” as described herein is any service or system that may be configured to facilitate creation and sharing of digital information or content between authenticated users. For example, an organization can maintain a collaboration system that includes a documentation platform and an issue tracking platform. The two platforms may be configured to integrate and/or share information or may function entirely separately. In some constructions, the system can include a single sign on service that manages user profiles for both the documentation platform and the issue tracking platform. In this manner, an employee of the organization can have a single set of credentials that can be provided by the employee to either or both the documentation platform or the issue tracking platform.

As noted above, many organizations may develop, maintain, or license custom tools configured to integrate with collaboration systems. For example, an organization may prefer to automatically stylize documentation system pages in a particular way, may prefer to connect the issue tracking platform to a contract management system or an invoicing system, and the like. As described herein, any software or code snippet configured to leverage one or more APIs of a collaboration system may be referred to as a “custom tool” for that collaboration system.

A custom tool as described herein can be executed and/or instantiated by a collaboration system backend, a collaboration system frontend, or may be instantiated or executed by a separate server or computing system, such as a virtual private cloud system, a virtual private computer, or another managed computing appliance that is communicably coupled to, or couplable to, data resources or APIs of a collaboration system.

Although not required, for simplicity of description, many embodiments described herein reference custom tools that are executed by computing resources provided as a service by a third party, typically referred to as “cloud compute” resources. In these examples, a host server with processing resources, memory resources, and networking resources can be configured (e.g., by a hypervisor) to allocate a portion of those resources to execution of computer code, such as computer code defining a custom tool as described herein.

In some cases, computer code associated with a custom tool can include a snippet executed by an anonymous function (e.g., a lambda function executed by cloud compute resources) that requests, processes, and/or provides information to an API endpoint of a collaboration system.

In other cases, computer code associated with a custom tool can include runtime executable instructions that, when executed by cooperation of processing and memory resources of a cloud compute platform can perform, coordinate, or monitor a process that requests information from and/or provides information to an API endpoint of a collaboration system.

In yet other examples, computer code associated with a custom tool can include a compiled executable that, as with preceding examples, can be configured to request, process, and/or provide information to an API endpoint of a collaboration system.

Independent of supporting infrastructure or hardware, a custom tool as described herein can be automatically called, instantiated, executed, or otherwise invoked in response to a user instruction or occurrence of an event or trigger within a collaboration system.

In some applications, a user may issue (e.g., via an interface, such as a frontend user interface of a collaboration system) a direct instruction to invoke a particular custom tool. For example, an affordance can be rendered within a user interface that also depicts a page of a documentation platform. Interaction by the user with the affordance can cause a custom tool to perform a function with the content of the page. For example, the custom tool may apply formatting rules to the content of the page, summarize the content of the page with a generative output system, send a notification to one or more users of the collaboration system, or the like. In other applications, a custom tool can be invoked automatically in response to the occurrence of an event within a collaboration system. Continuing the preceding example, a documentation platform may be integrated with a custom tool configured to automatically format pages in a particular, organization-specific way. In this example, when content of a page is changed, a documentation platform can cause the custom tool to be invoked automatically. In another example, when an issue is assigned in an issue tracking system, a custom tool may be automatically invoked.

As noted above, custom tools may be designed and architected in a number of suitable ways to perform any suitable function with collaboration system data. In many cases, it may be advantageous to store data in or access data from a database or database table specifically dedicated to a particular custom tool. For example, a custom tool may be configured to reformat a particular page of a documentation tool, render particular content within a frame of a page of a documentation tool, provide custom charting capabilities to a project management interface, or the like. In each of these and other examples, a developer of the custom tool may prefer to store data in a nonvolatile way so that different invocations of the custom tool can share a common memory space and/or save state history, as examples.

As known to a person of skill in the art, conventional relational databases (e.g., mySQL) leverage database-specific transport layer authentication that is often difficult to manage at scale. Further, conventional relational databases establish connections and authenticate connections with a user table specific to the database, again introducing permissions management complexity and remote connectivity complexity. To address these problems, conventional systems designed to provide remote access to relational databases either (1) open firewall ports to support direct remote database connections, (2) define custom APIs to request stateful data from remote services, or (3) encourage developers to manage their own data storage requirements.

The first solution is clearly unsuitable for commercial applications or collaboration systems for which information and data security is a priority.

In applications implementing the second conventional solution, developers may be restricted in what types of queries, transactions, and database metadata may be requested and returned from the remote database. Further, developers may be frustrated or delayed by requirements to study, implement, and maintain a new and service-specific API. Dedicating resources to integrating with a single service provider may not be efficient or advisable for long-term software maintenance objectives. Developers may prefer, instead, to store data locally (e.g., in a database local to the host server executing custom tool code) using conventional frameworks and libraries that facilitate connections, queries, and transactions with such local databases.

In some instances, even local storage may not be possible; some custom tools may be executed by anonymous and/or stateless functions, such as lambda functions. In these constructions, it may not be possible to store custom tool data in any location associated with execution of the custom tool. In these examples, developers may be motivated to persistently store custom tool data in yet a different location or format.

Further to the foregoing, in applications implementing the third conventional solution, developers may be unfamiliar with best practices and/or may store organization/collaboration system data in an insecure manner.

In any case, more broadly, conventional solutions often motivate developers of custom tools for collaboration systems to explore data storage limitation workarounds that result in collaboration system data, user data, customer data being stored in a location that is not under the control of an organization or a collaboration system host. More specifically, such data may be stored in a manner that is not in compliance with industry best practices, organization policies, laws, rules or regulations. As an example, a collaboration system may be used to store personally identifying information and/or personal health information. In such examples, introduction of a custom tool with poor data management practices can potentially expose the organization to disclosure liability.

More broadly, the use of custom tools for collaboration systems can introduce unnecessary information disclosure risk for an organization. To mitigate this risk, many organizations prohibit use of custom tools, significantly limiting the customizability of collaboration systems licensed by those organizations.

To address these and other problems associated with the motivation of developers of custom tools for collaboration platforms to store data outside of organization control, embodiments described herein relate to services for storing data in a secure and authenticated manner by exposing an interface that can be used by a developer in a substantially identical manner as a local database connection. More simply, embodiments described herein relate to systems and methods for emulating custom tools and associated software that leverage collaboration system APIs to perform functions, local database connections, without actually storing collaboration system data outside of a collaboration system control plane.

As a result of the emulation methods described herein, a developer can perform any operation supported by a particular database protocol used to connect to an emulated local database. Thus, developers can design their applications as though the developer were connecting to a local database fully within the control of that developer. For example, the developer can structure queries, transactions, perform table structure queries, and the like. Any database features the developer is motivated to implement and that is supported by a particular relational database protocol can be implemented in code using familiar design patterns and industry standard protocol wrappers or frameworks.

More simply, and without limitation, as a result of the architectures described herein, a developer is not required to study or otherwise learn a custom database access protocol, a new or system-specific API, new or unique database structures or query languages dialects.

Embodiments described herein provide this functionality by introducing a pair of protocol bridges configured to establish an authenticated application layer connection (e.g., WebSocket).

A first protocol bridge (which may be referred to as a shim, framework, plugin, or module) may be configured to execute local to the developer and a second protocol bridge may be configured to execute local to a remote relational database. The protocol bridges can be configured to package transport layer communications associated with local database connections into application layer data that, thereafter, can be passed between protocol bridges, unpackaged, and provided as transport layer input to a remote database. Similarly, a protocol bridge can be configured to receive transport layer communications/data from the remote database, package that data into application layer data, transmit the application layer data over an application layer protocol to the other protocol bridge which, in turn, unpackages the application layer data as transport layer communications/data to provide the same output as though the remote database were local to the originator of the initial input. In this manner, the pair of protocol bridges effectively serves as a local to remote relational database proxy.

From the developer's perspective and from the perspective of the developer's instantiated code, a local database connection is established and used for database operations. However, in lieu of connecting to a physical local database, the developer's instantiated code is in reality communicably coupling to a remote relational database, with all transport layer traffic intended for the “local” database wrapped/packaged as application layer data, transported and secured as application layer data, unwrapped/unpackaged as transport layer data, and provided as input to the remote database. Likewise, the inverse - transport layer data intended for the instantiated code can be wrapped, transported as application layer data, unwrapped, and provided to the instantiated code. In this manner, the developer's custom tool operates in the same manner as it would with an actual local database while no actual data is stored outside of collaboration system control and management.

Phrased in another nonlimiting manner, embodiments described herein can be referred to as systems configured to shift low-level (e.g., Open Systems Interconnect (OSI) model layer 4) database communications to higher level communications that collaboration system firewalls, gateways, and other security apparatuses and appliances are well-equipped to monitor and control. For example, a database connection as described herein can be authenticated with application layer authentication schemas (e.g., user, role, or developer access tokens) in addition to or in place of traditional transport layer and/or user table based relational database authentication. More specifically, application layer communications packaging transport layer communications can be provided with user-specific, tenant-specific, session-specific, and/or developer-specific access tokens or other credentials, in the same manner as any authenticated HTTPS request of data from the collaboration system would be provided.

Some embodiments described herein are also configured for rate limiting or other governing of database access such that a single poorly constructed query does not constrain backend resources of the collaboration system. For example, a number of database connections at a given time may be restricted, an amount of data retrieved from a database may be restricted, a number of queries per time period may be restricted, and so on.

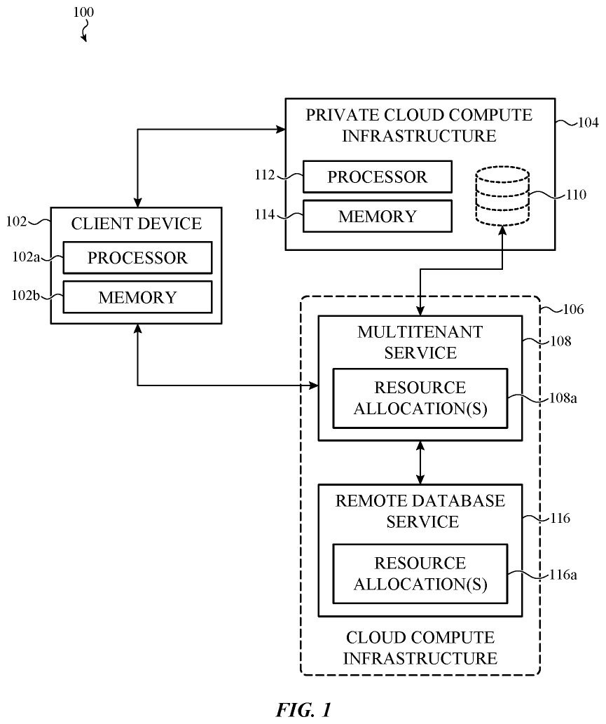

These foregoing and other embodiments are discussed below with reference to FIGS. 1-5. The following examples are provided with respect to these figures for purposes of illustration and example and should not be construed as limiting the disclosure to the explicit examples depicted.

FIG. 1 depicts a simplified system diagram of a collaboration system 100. The collaboration system 100 may be configured to communicably couple with a client device 102 that may be configured to leverage a processor 102a and a memory 102b to instantiate an instance of a frontend application (which may be a web browser) configured to retrieve information from and/or provide information to a corresponding backend application of the collaboration system 100.

For example, if the collaboration system 100 is configured as a documentation platform, the frontend application can be configured to request one or more pages from the documentation platform backend, and may render those pages (e.g., as HTML) within the frontend application. In addition, the frontend application can be configured to receive input from a user of the client device 102 that can be communicated via the frontend application back to the backend application.

As noted above, the collaboration system 100 may be configured as any suitable collaboration system type (e.g., documentation system, issue tracking system, project management system, information technology service management system, and so on) and may be configured to expose one or more APIs that encourage developers to design custom tools for the collaboration system 100.

Continuing the preceding example, in some embodiments, the collaboration system 100 may be a documentation platform. In this example, users or licensees of the documentation platform may build plugins, macros, or other purpose-configured custom tools to integrate with the documentation platform and to extend the functionality and/or customization thereof, for example by sending a custom notification to owners of a particular page when that page is changed by a user.

In other cases, the collaboration system 100 may be an issue tracking system. In this example, organizational users of the issue tracking system may design, develop, or license custom tools that generate custom email messages or other notifications in response to occurrence of events within the issue tracking system, such as assignment of an issue to a particular person or the like.

Broadly and independent of configuration, the collaboration system 100 can be configured for extendibility via macro, script, sidecar application, container, or the like. In many cases, a custom tool for the collaboration system 100 can be configured to leverage computing resources separate from infrastructure that executes backend functionality of the collaboration system 100. For example, in one configuration, a custom tool can be executed, invoked, or otherwise instantiated over private cloud compute resources managed by and/or allocated by a third-party cloud provider, such as the private cloud compute infrastructure 104.

For example, a custom tool may be a serverless function that executes over the private cloud compute infrastructure 104 in response to a signal from a multitenant service 108 associated with the collaboration system 100. In other cases, a custom tool may be a script, macro, or compiled executable configured to execute on a virtual computing instance supported by the private cloud compute infrastructure 104. In this example, the executable may be configured to receive an input from the client device 102 to cause the executable to access resources of the collaboration service 100 to perform a custom function.

The collaboration service 100 can be supported by cloud compute infrastructure. The collaboration system cloud compute infrastructure 106 can include resources dedicated to operation of a multitenant backend application that serves as a host for API requests associated with operation of the collaboration service 100. For example, the multitenant service 108 can be configured to receive requests from the client device 102 and/or requests from the private cloud compute infrastructure 104, initiated by operation of a custom tool such as described herein.

The backend application instance (e.g., the multitenant service 108) can be supported by resources of the collaboration system cloud compute infrastructure 106 allocated to operation thereof. For example, the collaboration system cloud compute infrastructure 106 can include processing resources and memory resources that may be allocated specifically for operation of the multitenant service 108 (e.g., the resource allocations 108a). In this manner, the processing resources and the memory resources of the collaboration system cloud compute infrastructure 106 allocated for operation of the multitenant service 108 can cooperate to instantiate the backend application instance that, together with frontend application instances, define the collaboration system 100.

As noted above, a developer of a custom tool as described herein may from time to time design an application or service that would benefit from persistent storage. To provide this functionality, the collaboration system 100 includes a remote database connection management feature that is configured to emulate a local database connection (e.g., the emulated local relational database 110) that may be used by the custom tool configured for integration with the collaboration system. As a result of this construction, collaboration system data - including data that may be generated by custom tools that leverage APIs of the collaboration system 100 - is retained by the collaboration system itself.

More specifically, the remote database connection management feature of the collaboration system can be provided with a protocol bridge instantiated within the private cloud compute infrastructure 104 (e.g., over resources of the private cloud compute infrastructure 104, such as by cooperation of a processor 112 and a memory 114) environment and configured to intercept/receive transport layer data facilitating communications between a database client (e.g., the custom tool) and repackage those transport layer data as application layer data, transmit the application layer data over a computing network to another protocol bridge, instantiated within the control plane of the collaboration system cloud compute infrastructure 106 and configured to perform the inverse operation of unpackaging transport layer data from the received application layer data. Specifically, the second protocol bridge can be instantiated as a portion of a remote database service 116.

Once application layer data is received by the second protocol bridge of the remote database service 116, the second protocol bridge provides the unpackaged transport layer data as input to a relational database of the remote database service 116, that may be persistently stored within a memory of a resource allocation 116a. In this manner, from the perspective of the custom tool instantiated/invoked over the private cloud compute infrastructure 104, it is coupled directly to the relational database (e.g., coupled directly to the emulated local relational database 110).

In this way, the system emulates for the custom tool, a local and native database connection, despite that the actual relational database to which the client is connected is under the control and administration of the collaboration system 100 itself, physically separated from the database client/custom tool by a computer network.

These foregoing embodiments depicted in FIG. 1 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

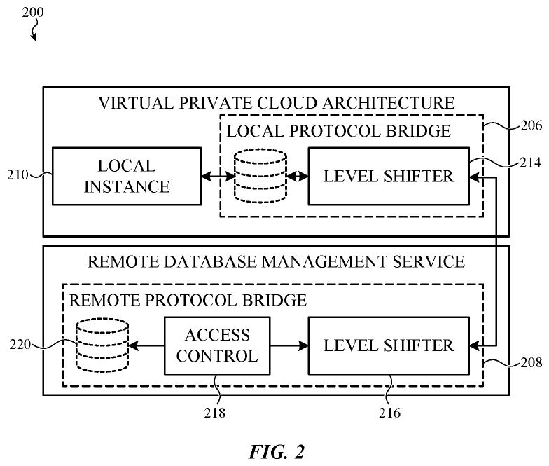

FIG. 2 depicts a simplified system diagram of a portion of a collaboration system including a remote database connection management system as described herein. As with other described embodiments, the system 200 includes a virtual private cloud infrastructure 202 to execute or invoke computer code associated with custom tools configured to interface with one or more collaboration systems. The virtual private cloud infrastructure 202 can be communicably coupled to a remote database management service 204 of a collaboration system as described herein.

The virtual private cloud infrastructure 202 includes a local protocol bridge 206 that is coupled to a remote protocol bridge 208 of the remote database management service 204. The local protocol bridge 206 is configured to communicably couple to a custom tool 210, and to receive native database communications therefrom. As known to a person of skill in the art, such communications may be provided over one or more transport layer protocols (e.g., TCP). The local protocol bridge 206 is configured to receive these transport layer communications from the custom tool 210 and to provide corresponding transport layer output back to the custom tool 210. In this manner, the custom tool 210 operates as though it is connected to a local database, the emulated local database 212.

More particularly, the local protocol bridge 206 is configured to receive transport layer communications from the custom tool 210 and package those communications into application layer data via a level shifter 214. Any suitable packaging, packetization, segmentation, encryption, encapsulation, or level-shifting technique may be used.

The application layer data thereafter can be transmitted from the local protocol bridge 206 to the remote protocol bridge 208 via application layer protocols, such as HTTP or web sockets. As a result of translation by the level shifter 214 to application layer data, existing firewall rules, data handling, and authentication techniques implemented within a collaboration system as described herein can be applied to control, authenticate, and/or route the application layer data.

The application layer data transmitted by the level shifter 214 can be received by the remote database management service 204 at the remote protocol bridge 208 and, in particular, at a level shifter 216 that is configured to unpackage the received application layer data to a transport layer data stream that, in turn, can be provided as input to a rate limiter 218 or other monitoring element or, in some cases, may be provided as input directly to a relational database 220. The rate limiter 218 can be configured to gate access to the relational database 220, to prevent overloading, request spamming, data exfiltration, and/or constraining of compute resources. In many cases, the rate limiter 218 can also define a query timeout period to effectively limit complexity of queries that can be executed by the relational database 220.

Upon being passed by the rate limiter 218, transport layer data output from the level shifter 216 can be received at the relational database 220. In turn, the relational database 220 can provide output responsive to the input. This output may, in many cases, be formatted as transport layer data that can likewise be received as input at the level shifter 216, shifted to the application layer by the level shifter 216, transmitted via a computing network to the level shifter 214, shifted back to the transport layer by the level shifter 214, and provided as output to the custom tool 210.

As a result of this construction, the custom tool 210 can operate as though it is directly connected to a local relational database (e.g., the emulated local database 212), and collaboration system data can be retained and protected behind appropriate firewalls and information technology security infrastructure of the collaboration system.

These foregoing embodiments depicted in FIG. 2 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

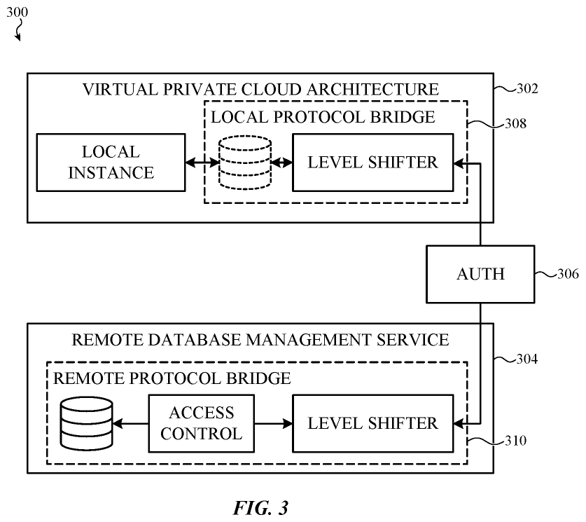

For example, as noted above, shifting transport layer data streams or communications to application layer data or application layer content/communications can allow for the use of existing security and authentication apparatuses and systems to control access to relational databases. For example, FIG. 3 depicts a simplified system diagram 300 of a portion of a collaboration system including a remote database connection management system with application layer authentication as described herein. In this example, as with others described herein, a custom tool can be supported by a virtual private cloud infrastructure 302 that is communicably coupled to a remote database management service 304 of a collaboration system.

Communications between the virtual private cloud infrastructure 302 and the remote database management service 304 can be monitored and/or gated by an application layer authentication and authorization controller 306. The application layer authentication and authorization controller 306 can be configured to receive application layer communications and/or data requests, and determine whether those requests originate from authorized users of the collaboration system (e.g., by validating an authentication token presented with application layer communications, requests, and data). In particular, in many embodiments, the application layer authentication and authorization controller 306 can be configured to determine whether a particular request includes an authentication or authorization token that has been issued to a particular user, developer, or other role associated with a permissions set within the collaboration tool. If the application layer authentication and authorization controller 306 does not recognize a valid token, a request from the virtual private cloud infrastructure 302 will be denied, regardless of the content of that request.

As a result of this architecture, access to a relational database as described herein can be controlled and managed using authentication systems of the collaboration system. For example, as with previous embodiments, the virtual private cloud infrastructure 302 can be provided with a local protocol bridge 308 that is configured to shift transport layer communications to the application layer and vice versa. Similarly, the remote database management service 304 can be provided with a remote protocol bridge 310 that is likewise configured to shift transport layer communications to the application layer, and vice versa. In this manner, all database connectivity requests, access requests and connection request must be accompanied by appropriate collaboration tool credentials (as verified by the application layer authentication and authorization controller 306) for access to a relational database of the remote database management service 304 to be granted.

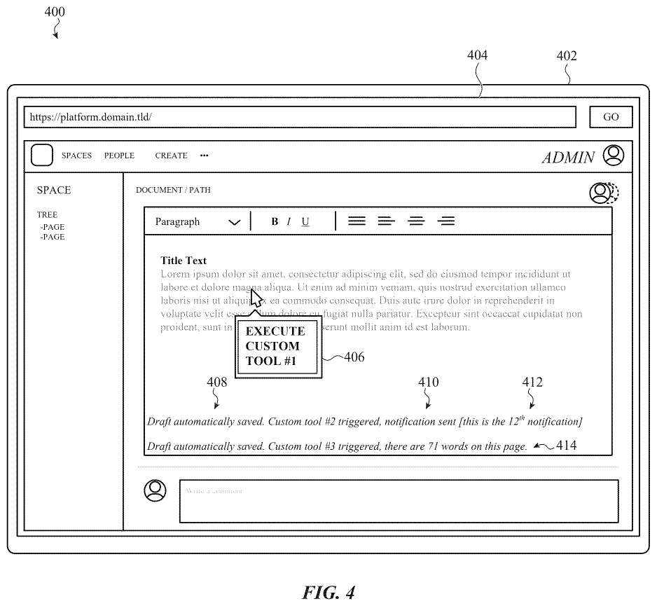

These foregoing embodiments depicted in FIG. 4 and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

For example, it may be appreciated that a custom tool designed to store and/or access data as described herein may be invoked in a number of ways. FIG. 4 depicts a graphical user interface that may be rendered by operation of a processor and memory of a client device associated with a collaboration system.

More specifically, FIG. 4 depicts a client device 400 including a display 402 disposed within a housing. The client device 400 can include a processor, a memory, and/or other electronic components that cooperate to render a graphical user interface that can present information to a user of a collaboration system and/or receive information from a user of the collaboration system.

In an example, the collaboration system to which the client device 400 is coupled is a documentation platform and the graphical user interface (e.g., the frontend) is rendered within a browser window. The graphical user interface 404 can be configured to present navigation elements arranged in a structured manner, such as with a hierarchical view of one or more pages or spaces in which content of the documentation platform may be organized.

The graphical user interface 404 can also include a user input region and/or a user input region configured to receive text input. The graphical user interface 404 can likewise include a toolbar with affordances related to formatting, styling, or structuring of document content (e.g., paragraph styles, text styles, text format, and the like).

As noted above, the client device 400 can be operated by a user to access content of the collaboration system. In particular, in an embodiment, a user of the client device 400 can provide as input a URL or IP address of a backend application instance associated with the collaboration/documentation system. Thereafter, the frontend application instance can generate an HTTP request of the backend to receive HTML content therefrom which may be rendered in the graphical user interface 404 on the display 402. The request can include authentication tokens identifying the user of the client device 400 to the backend application instance. An example authentication token may be a JavaScript Web Token, but this is not required of all embodiments.

The received HTML can include page content and/or one or more affordances associated with functions of the documentation platform, as noted above. In addition, the HTML page content can include affordances enabling the user to engage with and/or otherwise invoke a custom tool (e.g., macro) that may be installed within (or otherwise communicably intercoupled with) the documentation platform environment. As noted above, in some cases, a custom tool may be manually invokable whereas in other cases, a custom tool may be automatically invokable. In either construction, a custom tool may be developed to store and/or access a relational database such as described herein.

For example, a manual invocation affordance 406 may be displayed as a control element overlaying a portion of a content area of the graphical user interface 404. The manual invocation affordance 406 can be configured to visually indicate to the user an interactive element that, upon user selection, may invoke a custom tool as described herein.

In other cases, a custom tool may be automatically invoked in response to an event associated with operation of the documentation platform. For example, an event may be a user interaction event, a page load event, an event triggered by another user, an event triggered by another application, an event triggered by another service, an event triggered by a system change or a state change, and so on. Many example events are possible.

Independent of event or the context in which a particular custom tool is automatically invoked, in some embodiments, the graphical user interface 404 can be updated to reflect a log or record of that invocation and/or a result therefrom. For example, text recording an automatic invocation record 408 can be rendered within the graphical user interface 404. In some cases, the automatic invocation record 408 can be accompanied by a record reflecting what action was performed by a custom tool in response to its invocation (e.g., an automatic invocation type 410 appears may be rendered adjacent to the automatic invocation record 408, indicating what action was performed). In some cases, a result of a relational database interaction by the custom tool can also be rendered (e.g., the automatic invocation data result 412).

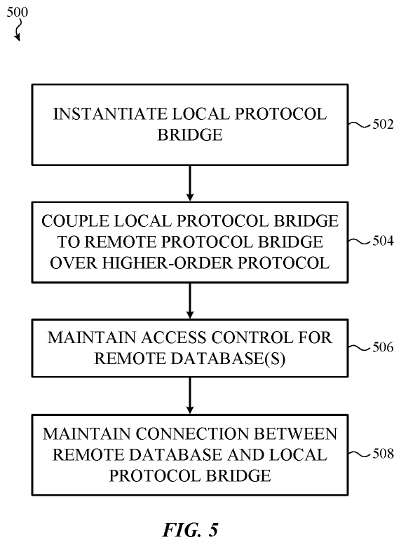

FIG. 5 depicts a flowchart depicting operations of another method of operating a remote database connection management system as described herein. The method 500 includes operation 502 at which a local protocol bridge may be instantiated local to a custom tool configured to integrate with a collaboration system as described herein. The custom tool may be instantiated over any suitable virtual or physical hardware and may in some cases be instantiated over a client device, such as the client device 102 as shown and described in reference to FIG. 1.

The method 500 further includes operation 504 at which the local protocol bridge can be communicably coupled to a remote protocol bridge over an application layer protocol or, more generally a higher-level or higher order protocol than a transport layer protocol that may be used to directly connect to a relational database. Next, at operation 506, an access control module can intercept or otherwise interpose requests between the local protocol bridge and the remote protocol bridge to ensure that requests from the local protocol bridge to the remote protocol bridge originate from authorized computing devices, developer accounts, and/or authorized users. Finally, at operation 508, a persistent connection can be established and maintained (e.g., via web sockets) such that communications between the local and remote protocol bridge are two-way and substantially real time.

FIG. 5 depicts a flowchart depicting operations of another method of operating a remote database connection management system as described herein. The method 600 includes operation 602 at which a database request or response on a transport layer. The request may be received at a protocol bridge as described herein. Next, at operation 604, the transport layer communication may be shifted to application layer data. Next at operation 606, the application layer data can be received alongside an authentication/authorization token associated with an originator of the database request at operation 602. Next, at operation 608, the token may be authenticated. Upon determining that the token is valid and permitted to access remote relational database(s), the method 600 can advance to operation 610 at which the application layer data may be unpackaged and shifted back to transport layer data. Finally, at operation 612, the transport layer data can be provided as input to a relational database, or in some cases, a database client such as a custom tool as described herein.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects, and functionality described in one or more of the individual embodiments are not limited in their applicability to the particular embodiment with which they are described, but instead can be applied, alone or in various combinations, to one or more of the embodiments of the invention, whether or not such embodiments are described, and whether or not such features are presented as being a part of a described embodiment. Thus, the breadth and scope of the present invention should not be limited by any of the above-described exemplary embodiments but is instead defined by the claims herein presented.

Furthermore, the foregoing examples and description of instances of purpose-configured software, whether accessible via API as a request-response service, an event-driven service, or whether configured as a self-contained data processing service are understood as not exhaustive. In other words, a person of skill in the art may appreciate that the various functions and operations of a system such as described herein can be implemented in a number of suitable ways, leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments described herein are described in reference to an implementation in which discrete functions of the system are implemented as discrete microservices. It is appreciated that this is merely one possible implementation.

In addition, it is understood that organizations and/or entities responsible for the access, aggregation, validation, analysis, disclosure, transfer, storage, or other use of private data such as described herein will preferably comply with published and industry-established privacy, data, and network security policies and practices. For example, it is understood that data and/or information obtained from remote or local data sources, only on informed consent of the subject of that data and/or information, should be accessed only for legitimate, agreed-upon, and reasonable uses.

What is claimed is:

1. A computer-implemented method of providing access via a collaboration system to a relational database as a service over a network, the method comprising:
receiving, at a backend of the collaboration system, an application layer data via the network to access a relational database, the application layer data comprising an authentication token;
determining that the authentication token is associated with permission to access at least one resource of the collaboration system;
in accordance with a determination that the authentication token has permission to access the relational database, establishing a connection between the backend of the collaboration system and an originator of the application layer request;
receiving, via the connection, first packaged application layer data;
unpackaging, as transport layer data, the first packaged application layer data, the transport layer data comprising a query of the relational database;
providing, by the collaboration system, the query to the relational database and, in response, receiving a result;
packaging the result as second packaged application layer data; and
transmitting, via the connection, the second packaged application layer data to the originator.

2. The method of claim 1, wherein determining that the authentication token is associated with a user that has permission to access at least one resource of the collaboration system comprises determining whether the user has permission to access the relational database.

3. The method of claim 1, wherein the collaboration system comprises a first protocol bridge configured to:
unpackage the first packaged application layer data;
package the second packaged application layer data; and
communicably coupled to a second protocol bridge instantiated over processing and computing resources separate from the collaboration system.

4. The method of claim 3, wherein the second protocol bridge is instantiated over third party cloud compute resources.

5. The method of claim 1, wherein the query inserts, modifies, or obtains data from the relational database.

6. The method of claim 1, wherein the query obtains information about the structure of the relational database.

7. The method of claim 1, wherein the authentication token is issued to a developer account associated with the collaboration system.

8. The method of claim 1, wherein the first packaged application layer data is received in response to invocation of a custom tool configured to access at least one application programming interface of the collaboration system.

9. The method of claim 8, wherein the custom tool comprises a macro, script, or lambda function.

10. A computer-implemented method of accessing over a network a remote relational database hosted by a collaboration system, the method comprising:
requesting, via invocation of a function, to query the remote relational database;
receiving first transport layer data associated with the query of the remote relational database;
packaging the transport layer data as first application layer data;
assembling a first application layer data, the application layer data comprising an authentication token and the first application layer data;
transmitting the first application layer data to the collaboration system over the network;
receiving, in response to the first application layer data, a second application layer data comprising second application layer data;
unpackaging the second application layer data to extract second transport layer data received from the remote relational database in response to the connection request; and
providing to the function, the second transport layer data as a response from the remote relational database.

11. The method of claim 10, wherein the function is associated with a custom tool configured to access at least one application programming interface of the collaboration system.

12. The method of claim 10, wherein the function is invoked automatically by the collaboration system.

13. The method of claim 10, wherein the function is invoked in response to an instruction received from a user of a frontend application instance associated with the collaboration system.

14. The method of claim 10, wherein the authentication token is associated with a developer authorized to access the collaboration system.

15. The method of claim 10, wherein the collaboration system comprises a documentation platform, an issue tracking system, or an information technology service management system.

16. The method of claim 16, wherein the function comprises a macro, script, or lambda function.

17. A computer-implemented method of accessing a relational database by proxy, the method comprising:
packaging, by a first protocol bridge, first transport layer database communications as first application layer data;
receiving at a second protocol bridge, the first application layer data;
unpackaging by the second protocol bridge, the first application layer data as the first transport layer database communications;
providing the first transport layer database communications as input to a relational database;
receive as output from the relational database, second transport layer database communications;
package, by the second protocol bridge, the second transport layer database communications as second application layer data;
transmit from the second protocol bridge to the first protocol bridge, the second application layer data;
receive, at the first protocol bridge, the second application layer data;
unpackage, by the first protocol bridge, the second application layer data to obtain the second transport layer database communications; and
provide the second transport layer database communications to a function originating the first transport layer database communications.

18. The method of claim 17, wherein the first protocol bridge and the second protocol bridge are communicably coupled via a network.

19. The method of claim 17, wherein both the first protocol bridge and the second protocol bridge are configured to:
receive transport layer communications as input and, in response, provide application layer communications as output; and
receive application layer communications as input and, in response, provide transport layer communications as output.

20. The method of claim 17, wherein the first application layer data is provided with an authentication token associated with a collaboration system.
